(19) United States
(12) Patent Application Publication
(10) Pub. No.: US 2004/0178029 A1
(43) Pub. Date: Sep. 16, 2004

(54) Lightweight brake rotor with cooling passageways

(75) Inventors: David S. Hoyte, Sheboygan, WI (US); Alan Honggen Jiang, Sheboygan Falls, WI (US); Kwok-Sang Chui, Columbus, IN (US)

Correspondence Address: MICHAEL BEST & FRIEDRICH, LLP, 100 E WISCONSIN AVENUE, MILWAUKEE, WI, 53202, US

(73) Assignee: J. L. French Automotive Castings, Inc., Sheboygan, WI

(21) Appl. No.: 10/388,124

(22) Filed: Mar. 13, 2003

(51) Int. Cl. F16D 65/10

(52) U.S. Cl. 188/218 XL

(57) ABSTRACT

A brake rotor including a rotor body made of a first material. The rotor body includes a central hub portion and a substantially annular disc portion extending from the central hub portion. The disc portion includes an inner disc surface and an outer disc surface. The brake rotor also includes an inner braking ring and an outer braking ring made of a second material. The inner and outer braking rings are fastened to the rotor body in an orientation substantially parallel with the disc portion and spaced from the respective inner and outer disc surfaces. The brake rotor includes projections extending from at least one of the inner and outer disc surfaces to support thereon the respective one of the inner braking ring and the outer braking ring. The projections are generally configured in elongated diamond-like shapes oriented along an axis extending radially outwardly from the central hub portion.

### BACKGROUND OF THE INVENTION

This invention relates generally to braking components, and more particularly to brake rotors.

Brake rotors are important components of disc brake systems used in overland vehicles. Generally, brake rotors include a braking surface that is frictionally engaged by brake pads mounted on calipers. The size, weight, and other attributes of brake rotors are highly variable. Brake rotors must be designed to provide adequate braking forces to a vehicle when the vehicle is fully loaded. In addition, brake rotors must be designed with an acceptable service life. A passenger vehicle, for example, typically utilizes relatively large and heavy brake rotors to provide the service life and braking forces required by such a vehicle.

Commonly used brake rotors are often manufactured from a cast iron, which has generally acceptable hardness and wear resistance properties. However, cast iron has a relatively high material density compared to other materials and a relatively low thermal conductivity. As a consequence, cast iron brake rotors are often unnecessarily heavy, and can not dissipate heat as efficiently as brakes made from other materials. Even under common driving conditions, poor heat dissipation can result in decreased brake performance. In high-performance and racing applications, poor heat dissipation is unacceptable.

From an energy standpoint, a relatively large amount of energy is required to accelerate the large, heavy, cast iron brake rotors that are found in most passenger vehicles. Also, relatively large braking forces are required to decelerate such rotors. The weight of the rotors also increases the overall weight of the vehicle. Generally, excess weight negatively impacts handling and fuel economy.

While it is known to replace cast iron with aluminum in brake rotors to decrease weight and increase heat dissipation, in most designs the weight reduction actually achieved is relatively insignificant and the complexity of manufacturing is increased to an unacceptable level.

### SUMMARY OF THE INVENTION

Accordingly, there is a need for lighter and better performing brake rotors that can be manufactured with a relatively simple process. In one aspect, the invention provides a brake rotor generally including a rotor body made of a first material having a central hub portion and a substantially annular disc portion extending from the central hub portion. The disc portion includes an inner disc surface and an outer disc surface. The brake rotor also generally includes an inner braking ring made of a second material, the inner braking ring being fastened to the rotor body in an orientation substantially parallel with the disc portion and spaced from the inner disc surface, and an outer braking ring made of a second material, the outer braking ring being fastened to the rotor body in an orientation substantially parallel with the disc portion and spaced from the outer disc surface. A plurality of projections extend from at least one of the inner disc surface and the outer disc surface to support thereon the respective one of the inner braking ring and the outer braking ring. The projections are generally configured in elongated diamond-like shapes oriented along an axis extending radially outwardly from the central hub portion.

In another aspect, the invention provides a brake rotor generally including a rotor body made of a first material and having a central hub portion and a substantially annular disc portion extending from the central hub portion. The disc portion includes an inner disc surface and an outer disc surface. The brake rotor also generally includes an inner braking ring made of a second material, the inner braking ring being fastened to the rotor body in an orientation substantially parallel with the disc portion and spaced from the inner disc surface, and an outer braking ring made of a second material, the outer braking ring being fastened to the rotor body in an orientation substantially parallel with the disc portion and spaced from the outer disc surface. A plurality of projections extend from at least one of the inner disc surface and the outer disc surface to support thereon the respective one of the inner braking ring and the outer braking ring. A combination of two adjacent projections, the respective disc surface, and the respective braking ring form a converging-diverging nozzle to accelerate a cooling airflow past the respective disc surface and the respective braking ring.

In yet another aspect, the invention provides a brake rotor generally including a rotor body made of a first material and having a central hub portion and a substantially annular disc portion extending from the central hub portion. The disc portion includes an inner disc surface and an outer disc surface. The brake rotor also generally includes an inner braking ring made of a second material, the inner braking ring being fastened to the rotor body in an orientation substantially parallel with the disc portion and spaced from the inner disc surface, and an outer braking ring made of a second material, the outer braking ring being fastened to the rotor body in an orientation substantially parallel with the disc portion and spaced from the outer disc surface. A plurality of elongated projections extend from at least one of the inner disc surface and the outer disc surface to support thereon the respective one of the inner braking ring and the outer braking ring. The projections are arranged in at least two radially spaced circular rows about the disc portion. The projections in any particular row are radially misaligned with the projections in any adjacent row.

In a further aspect, the invention provides a method of manufacturing a brake rotor. The method generally includes forming a rotor body to have a hub portion and a disc portion extending from the hub portion, the disc portion having a first side and a second side. The method also generally includes configuring the first side of the disc portion with a plurality of support columellae. The support columellae on the first side of the disc portion partially defining cooling passageways through the brake rotor. Further, the method generally includes fastening a braking ring to the first side of the disc portion of the rotor body such that the braking ring is supported by the support columellae. The cooling passageways are defined by the disc portion of the rotor body, the support columellae, and the braking ring.

In another aspect, the invention provides a brake rotor generally including a rotor body made of a first material and including a central hub portion having a central axis and a disc portion extending from the central hub portion. The disc portion includes a first surface and a second surface. The first surface of the disc portion has a plurality of columellae arranged in concentric rings coaxial to the central axis. The second surface of the disc portion has a plurality of columellae arranged in concentric rings coaxial to the central axis. The brake rotor also generally includes a first braking ring made of a second material, the first braking ring sized and shaped to be connected to the rotor body in an orientation substantially parallel with the disc portion, spaced from the first disc surface, and supported by the plurality of columellae of the first surface, and a second braking ring made of a second material, the second braking ring sized and shaped to be connected to the rotor body in an orientation substantially parallel with the disc portion, spaced from the second disc surface, and supported by the plurality of columellae of the second surface.

In yet another aspect, the invention provides a brake rotor body generally including a hub portion having a central axis and a disc portion extending from the central hub portion. The disc portion includes a first surface and a second surface. The first surface of the disc portion has a first plurality of columellae arranged in a first ring coaxial to the central axis and a second plurality of columellae arranged in a second ring coaxial to the central axis. The second surface of the disc portion has a first plurality of columellae arranged in first ring coaxial to the central axis and a second plurality of columellae arranged in a second ring coaxial to the central axis.

Further features and aspects of the present invention, together with the organization and manner of operation thereof, will become apparent from the following detailed description of the invention when taken in conjunction with the accompanying drawings, wherein like elements have like numerals throughout the drawings.

### BRIEF DESCRIPTION OF THE DRAWINGS

In the drawings:

FIG. 1 is an exploded perspective view of a brake rotor embodying aspects of the invention.

FIG. 2 is an exploded reverse perspective view of the brake rotor of FIG. 1.

FIG. 3 is a top view of the assembled brake rotor of FIG. 1, illustrating a partial cutaway of an outer braking ring.

### DETAILED DESCRIPTION

Before embodiments of the invention are explained in detail, it is to be understood that the invention is not limited in its application to the details of the examples set forth in the following description or illustrated in the drawings. The invention is capable of other embodiments and of being practiced or carried out in a variety of applications and in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. The terms “mounted,” “connected,” and “coupled” are used broadly and encompass both direct and indirect mounting, connecting, and coupling. Further, “connected” and “coupled” are not restricted to physical or mechanical connections or couplings.

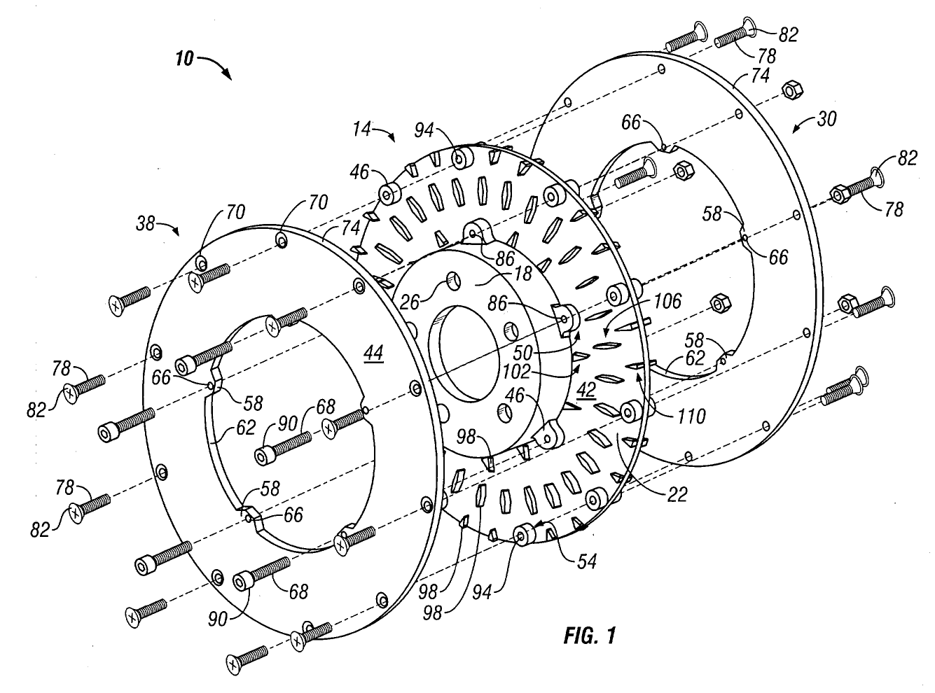

With reference to FIGS. 1-3, an exemplary brake rotor 10 is shown. Generally, the brake rotor 10 includes a rotor body 14 having a central hub portion 18 and a disc portion 22. The brake rotor 10 mounts to a vehicle's spindle (not shown) via the central hub portion 18. The central hub portion 18 further includes spaced apertures 26 therethrough to affix wheel studs (not shown). Alternatively, if the brake rotor 10 is driven, the wheel studs may be affixed to an axle or constant velocity (“C-V”) joint, and the central hub portion 18 may be inserted upon the axle or C-V joint such that the wheel studs protrude through the spaced apertures 26.

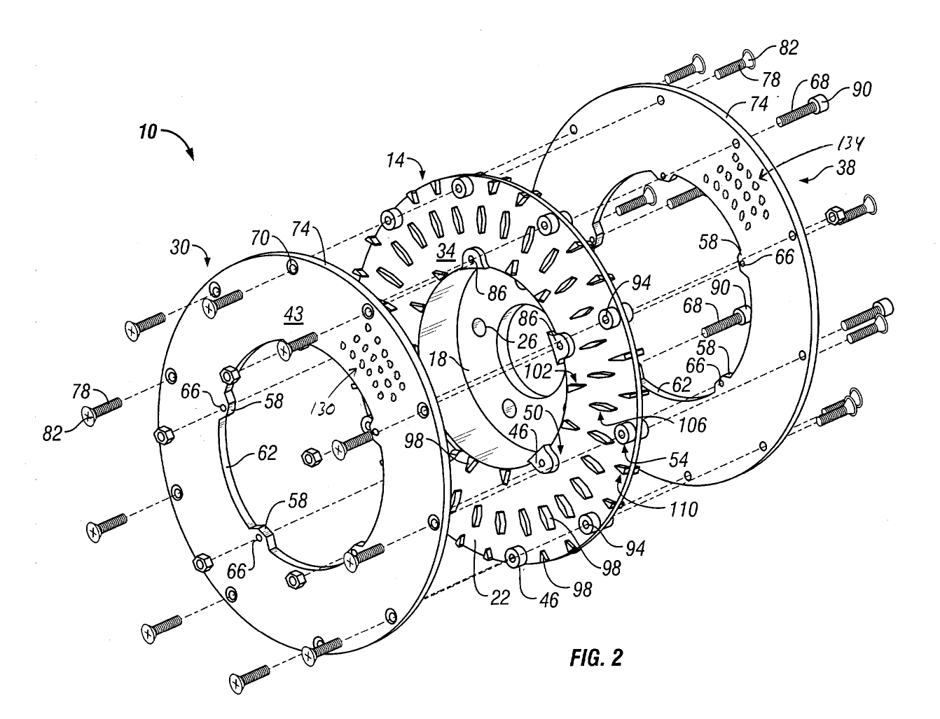

As shown in FIGS. 1-2, an inner braking ring 30 is coupled to the rotor body 14 on one side of the disc portion 22, and spaced a distance from an inner disc surface 34 of the disc portion 22. An outer braking ring 38 is coupled to the rotor body 14 on the other side of the disc portion 22, and spaced a distance from an outer disc surface 42 of the disc portion 22. The inner and outer braking rings 30, 38 are coupled to the rotor body 14 such that, when the brake rotor 10 is assembled to the spindle positioned in the vehicle's wheel well, the inner braking ring 30 faces the inside of the wheel well and the outer braking ring 38 faces the outside of the wheel well. The braking rings 30, 38 provide respective braking surfaces 43, 44 that are frictionally engaged by a caliper through brake pads (not shown).

As shown in FIGS. 1-2, the braking rings 30, 38 fasten to the rotor body 14 at locations on the rotor body 14 defining bosses 46. The bosses 46 support the braking rings 30, 38 on the rotor body 14. Bosses 46 are defined on both the inner and outer disc surfaces 34, 42, and are generally arranged in two circular rows, an innermost circular row 50 and an outermost circular row 54, concentric with the central hub portion 18. The innermost circular row 50 is defined on the rotor body 14 at a location adjacent the central hub portion 18, while the outermost circular row 54 is defined on the rotor body 14 at a location near the outer periphery of the disc portion 22. In the exemplary construction of FIGS. 1-2, five bosses 46 are utilized in the innermost circular row 50 on both the inner disc surface 34 and the outer disc surface 42, while ten bosses 46 are utilized in the outermost circular row 54 on both the inner disc surface 34 and the outer disc surface 42. Alternatively, in another construction of the brake rotor 10, a different number of bosses 46 may be utilized in the innermost and outermost circular rows 50, 54. Depending on the intended application, and the magnitude of frictional braking forces transferred from the braking rings 30, 38 to the rotor body 14, it might be desirable to utilize an increased or decreased number of bosses 46 to support and secure the braking rings 30, 38 to the rotor body 14.

With continued reference to FIGS. 1-2, the inner and outer braking rings 30, 38 are substantially identical in form in the illustrated embodiments. The braking rings 30, 38 include attachment tabs 58 defined around an inner perimeter surface 62 of the braking rings 30, 38. The attachment tabs 58 protrude from the inner perimeter surface 62 and include apertures 66 therethrough. Fasteners 68 pass through the apertures 66 to secure the braking rings 30, 38 to the innermost circular row 50 of bosses 46. The braking rings 30, 38 also include chamfered apertures 70 formed around a location adjacent an outer perimeter surface 74 of the braking rings 30, 38. Additional fasteners 78 pass through the chamfered apertures 70 to secure the braking rings 30, 38 to the rotor body 14. When the braking rings 30, 38 are assembled to the rotor body 14, the chamfered apertures 70 allow the ends of the fasteners, or fastener heads 82, that secure the braking rings 30, 38 to the outermost circular row 54 of bosses 46 to recess into the chamfered apertures 70. This is done to allow the brake pads to frictionally engage the braking surfaces 43, 44 of the braking rings 30, 38 without concern of the brake pads contacting the fastener heads 82. The fastener heads 82 are recessed into the chamfered apertures 70 to allow ample room for wear of the braking rings 30, 38 before replacement. As previously stated, if the rotor body 14 is formed with more or fewer bosses 46 as the exemplary construction of FIGS. 1-2, the number of attachment tabs 58 and chamfered apertures 70 will also vary accordingly.

Again, with continued reference to FIGS. 1-2, the braking rings 30, 38 are fastened to the rotor body 14 through the bosses 46. The innermost circular row 50 of bosses 46 include apertures 86 therethrough to allow the fasteners 68, such as conventional nuts and bolts, rivets, or similar fasteners to pass through the braking rings 30, 38 and the rotor body 14 to secure the assembly together. Such fasteners 68 may be used to secure the braking rings 30, 38 to the innermost circular row 50 of bosses 46 because the brake pads are not in contact with the braking rings 30, 38 at the attachment tabs 58. Further, the ends 90 of the fasteners 68, such as the head of the bolt and the nut, may protrude from the respective braking surfaces 43, 44 of the braking rings 30, 38 in contact with the brake pads. Alternatively, in another construction of the brake rotor (not shown), chamfered apertures may also be used in the attachment tabs 58 to provide a recess for the ends 90 of the fasteners 68, such that the ends 90 of the fasteners 68 do not protrude from the respective braking surfaces 43, 44 of the braking rings 30, 38 in contact with the brake pads.

The outermost circular row 54 of bosses 46 include threaded apertures 94 to allow the fasteners 78, such as screws or rivets, to secure the braking rings 30, 38 to the rotor body 14. In the exemplary construction of the brake rotor 10 shown in FIGS. 1-2, separate sets of screws are utilized to secure the inner braking ring 30 and the outer braking ring 38 to the rotor body 14, respectively. The screws include fastener heads 82 in the form of tapered heads matching the chamfer angle of the chamfered apertures 70 in the braking rings 30, 38. As a result, the screws tightly engage the braking rings 30, 38. Also, the tapered heads of the screws are recessed from the braking surfaces 43, 44 of the braking rings 30, 38 in contact with the brake pads. Alternatively, in another construction of the brake rotor (not shown), the outermost circular row 54 of bosses 46 include apertures therethrough to allow deformable fasteners, such as rivets, to secure the braking rings 30, 38 and the rotor body 14 together.

With continued reference to FIGS. 1-2, the rotor body 14 includes multiple vane-like projections or columellae 98 (which are generically referred to herein as vanes) protruding from both inner and outer disc surfaces 34, 42. As shown in the exemplary construction of FIGS. 1-2, the columellae 98 are arranged in circular rows (e.g., an innermost circular row 102, a middle circular row 106, and an outermost circular row 110) concentric with the central hub portion 18. The columellae 98 protrude substantially the same amount from the inner and outer disc surfaces 34, 42 as the bosses 46 to provide additional support to the braking rings 30 and 38.

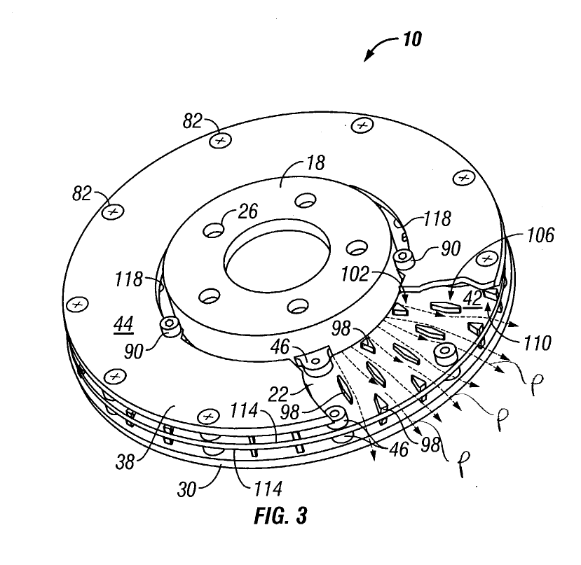

The columellae 98 define cooling air passageways 114 between the respective disc surfaces 34, 42 and the braking rings 30, 38. The inner perimeter surface 62 of the braking rings 30, 38 are sized with a larger diameter than the diameter of the central hub portion 18. As a result, when the braking rings 30, 38 are assembled to the rotor body 14 (see FIG. 3), an annular opening 118 is formed between the central hub portion 18 and the inner perimeter surface 62 of the outer braking ring 38 to promote a flow of cooling air through the annular opening 118 and between the outer disc surface 42 and the outer braking ring 38. Also, the brake rotor 10 is open in the interior section of the central hub portion 18 (see FIG. 2), thus providing another annular opening (not shown) between the inner disc surface 34 and the inner braking ring 30 to promote a flow of cooling air through the annular opening between the inner disc surface 34 and the inner braking ring 30.

As shown in the exemplary airflow through the brake rotor 10 in FIG. 3, the columellae 98 arranged in the middle circular row 106 are generally configured in elongated diamond-like shapes and oriented radially on the disc portion 22. The columellae 98 in the inner row 102 and outer row 110 are triangularly shaped. The configuration of two adjacent columellae 98 (shaped as illustrated in the drawings) accelerates the flow of air past the columellae 98. This is the result of the columellae 98 of the middle circular row 106 approximating converging-diverging nozzles in the air passageways 114 formed between the respective disc surfaces 34, 42 and the braking rings 30, 38. By increasing the flow of air between the respective disc surfaces 34, 42 and the braking rings 30, 38, the brake rotor 10 is more efficiently and rapidly cooled, generally leading to increased performance and longevity of the brake rotor 10.

Further, columellae 98 arranged in the innermost circular row 102 and the outermost circular row 110 are generally configured as triangular or wedge-like shapes that are radially oriented on the disc portion 22. The columellae 98 of the innermost circular row 102 and outermost circular row 110 are radially aligned on the disc portion 22, while the columellae 98 of the middle circular row 106 are misaligned from the columellae 98 of the innermost circular row 102 and the outermost circular row 110.

In the exemplary construction of the brake rotor 10 shown in FIG. 3, both the configurations and the arrangement of the columellae 98 on the rotor body 14 promote “free movement” of air during rotation of the brake rotor 10 in a vehicle. During such “free movement,” air entering the annular openings 118 is allowed to flow through the brake rotor 10 in an almost unpredictable path, such that a large amount of area of the rotor body 14 is cooled by the airflow through the brake rotor 10. Generally, however, air will flow in the paths designated by the dashed arrows P in FIG. 3. Further, the columellae 98 act as heat sinks for the braking rings 30, 38 since the columellae 98 are in abutting contact with the braking rings 30, 38. As a result, the cooled braking rings 30, 38 fastened to the rotor body 14 provide increased performance over conventional, brake rotors.

Preferably, the rotor body 14 is cast from aluminum or an aluminum alloy. Alternatively, the rotor body 14 may be machined from a billet material, rather than being cast from molten metal. Also, the rotor body 14 may be made of a material other than aluminum, although it is preferred to use material less dense than steel. The columellae 98 and the bosses 46 are cast with the rotor body 14, such that relatively little finish work or machining is required to complete the rotor body 14. In the case of the exemplary rotor body 14 in FIGS. 1-2, the apertures 86, 94 in the bosses may be formed during casting of the rotor body 14. However, additional machining may be required in the bosses 46 to form threads, for example, when using threaded fasteners. In the case of the exemplary rotor body 14, threaded fasteners 78 are used to secure the braking rings 30, 38 to the rotor body 14. Therefore, a machining process is required to form the threads in the apertures 94.

Preferably, the inner and outer braking rings 30, 38 are stamped from sheet metal, such as steel, stainless steel, high-strength steel, or titanium. Other materials, including non-metals such as ceramics or composite materials might also be used to make the rings 30 and 38. The attachment tabs 58 and the apertures 66 are also formed during the stamping process, which can be achieved using conventional methods and technologies such as stamping dies and stamping presses. Stamping the braking rings 30, 38 provides a product that requires little, if any, additional machining to achieve a final product (However, in the case of the exemplary braking rings 30, 38 in FIGS. 1-2, the chamfered apertures 70 may require additional machining to provide the chamfer). Another benefit of stamping is that stamping dies are re-usable. Thus, stamping the braking rings 30, 38 from sheet metal is highly economical and productive. Alternatively, the braking rings 30, 38 may be cast and/or machined from a billet material, rather than being stamped from sheet metal. Generally, the braking rings 30, 38 may be made of any metal harder and with a higher melting temperature than the material used to make the rotor body 14. Assembly of the braking rings 30, 38 onto the rotor body 14 may be accomplished using an automated assembly process, or may be accomplished by hand.

The exemplary brake rotors 10 that are illustrated and discussed dissipate heat more efficiently than conventional, cast iron brake rotors for a number of reasons. One of those reasons includes the desirable material properties of aluminum. The thermal conductivity of aluminum is about three times greater than cast iron, and the thermal diffusivity of aluminum is about four times greater than cast iron. Both of these material properties relate how well a material is able to conduct heat. As a result, the brake rotor 10 (having the aluminum rotor body) is able to dissipate the built-up heat at a higher rate than the cast iron brake rotor. Of course, the cooling passageways 114 formed between the respective braking rings 30, 38 also facilitate heat dissipation. As a consequence, the brake rotor 10 is generally capable of providing increased braking performance over a period of use, when compared to a cast iron brake rotor. Aluminum is also lighter in weight then cast iron. Thus, embodiments of the rotor described herein are lighter than conventional rotors.

In an alternative embodiment of the invention, the rings 30 and 38 may include a plurality of apertures. As shown in FIG. 2, the ring 30 may include apertures 130 and the ring 38 may include apertures 134. The apertures 130 and 134 enhance airflow in the passageways 114 and in combination with the passageways 114 provide enhanced airflow between the rings 30 and 38 helping to improve cooling and increase heat dissipation. The apertures 130, 134 are shown as circular in shape, but other shapes could be possible. Further, the apertures maybe configured in a variety of patterns.

As can be seen from the above, embodiments of the invention provide an improved brake rotor. Various features of embodiments of the invention are set forth in the following claims.

What is claimed is:

1. A brake rotor comprising:
a rotor body made of a first material, the rotor body including a central hub portion and a substantially annular disc portion extending from the central hub portion, the disc portion including an inner disc surface and an outer disc surface;
an inner braking ring made of a second material, the inner braking ring being fastened to the rotor body in an orientation substantially parallel with the disc portion and spaced from the inner disc surface;
an outer braking ring made of a second material, the outer braking ring being fastened to the rotor body in an orientation substantially parallel with the disc portion and spaced from the outer disc surface; and
a plurality of projections extending from at least one of the inner disc surface and the outer disc surface to support thereon the respective one of the inner braking ring and the outer braking ring, the plurality of projections partially defining a plurality of air passageways, a combination of two adjacent projections, the respective disc surface, and the respective braking ring forming a converging-diverging nozzle to accelerate a cooling airflow past the respective disc surface and the respective braking ring.

2. The brake rotor of claim 1, wherein the inner and outer braking rings include a plurality of apertures to enhance air flow in the air passageways.

3. The brake rotor of claim 1, wherein the inner and outer braking rings are made of material selected from the group of steel, titanium, ceramic, or composite material.

4. The brake rotor of claim 1, wherein the inner and outer braking rings are connected to bosses defined by the rotor body adjacent the central hub portion, and wherein the inner and outer braking rings are connected to bosses defined by the rotor body at a location spaced from the central hub portion.

5. The brake rotor of claim 1, wherein at least some of the plurality of the projections are generally configured in elongated diamond-like shapes oriented along an axis extending radially outwardly from the central hub portion.

6. The brake rotor of claim 5, wherein the projections are arranged on the inner and outer disc surfaces in a first circular row concentric with the central hub portion.

7. The brake rotor of claim 6, further comprising a second circular row of elongated wedge-shaped projections concentric with the first circular row, the projections of the second circular row being misaligned with the projections of the first circular row.

8. The brake rotor of claim 7, further comprising a third circular row of elongated wedge-shaped projections concentric with the first and second circular rows, the projections of the third row being misaligned with the projections of the first row, and the projections of the third row being aligned with the projections of the second row.

9. A brake rotor comprising:
a rotor body made of a first material, the rotor body including a central hub portion and a substantially annular disc portion extending from the central hub portion, the disc portion including an inner disc surface and an outer disc surface;
an inner braking ring made of a second material, the inner braking ring being fastened to the rotor body in an orientation substantially parallel with the disc portion and spaced from the inner disc surface;
an outer braking ring made of a second material, the outer braking ring being fastened to the rotor body in an orientation substantially parallel with the disc portion and spaced from the outer disc surface; and
a plurality of projections extending from at least one of the inner disc surface and the outer disc surface to support thereon the respective one of the inner braking ring and the outer braking ring, the projections being generally configured to act as vanes and oriented along an axis extending radially outwardly from the central hub portion.

10. The brake rotor of claim 9, further comprising a plurality of bosses extending from the inner and outer disc surfaces to support thereon the inner and outer braking rings, respectively, the inner and outer braking rings being fastened to the rotor body at the bosses.

11. The brake rotor of claim 10, wherein the bosses are arranged about the inner and outer disc surfaces in two concentric circular rows, a first row of bosses being positioned adjacent the central hub portion, and a second group of bosses being positioned along an outer periphery of the disc portion.

12. The brake rotor of claim 11, wherein the first row of bosses include apertures therethrough, and wherein the inner and outer braking rings are connected to the rotor body via the apertures in the first row of bosses.

13. The brake rotor of claim 11, wherein the second row of bosses include apertures therethrough, and wherein the inner and outer braking rings are connected to the rotor body via the apertures in the second row of bosses.

14. The brake rotor of claim 11, wherein the second row of bosses include threaded apertures, and wherein the inner and outer braking rings are screwed to the rotor body via the threaded apertures in the second row of bosses.

15. The brake rotor of claim 9, wherein the rotor body is made of aluminum.

16. The brake rotor of claim 9, wherein the inner and outer braking rings are made of a material selected from the group of steel, titanium, ceramic, or composite material.

17. The brake rotor of claim 9, wherein the projections extend from both the inner disc surface and the outer disc surface to support the inner braking ring and the outer braking ring, respectively, a distance from the inner disc surface and the outer disc surface.

18. The brake rotor of claim 17, wherein adjacent projections define cooling air passageways between a respective disc surface and braking ring.

19. The brake rotor of claim 17, wherein adjacent projections are configured to accelerate an airflow moving radially outwardly from the central hub portion.

20. The brake rotor of claim 17, wherein the projections are arranged on the inner and outer disc surfaces in a first circular row concentric with the central hub portion.

21. The brake rotor of claim 20, further comprising a second circular row of elongated wedge-shaped projections concentric with the first circular row, the projections of the second circular row being misaligned with the projections of the first circular row.

22. The brake rotor of claim 21, further comprising a third circular row of elongated wedge-shaped projections concentric with the first and second circular rows, the projections of the third row being misaligned with the projections of the first row, and the projections of the third row being aligned with the projections of the second row.

23. A brake rotor comprising:
a rotor body made of a first material, the rotor body including a central hub portion and a substantially annular disc portion extending from the central hub portion, the disc portion including an inner disc surface and an outer disc surface;
an inner braking ring made of a second material, the inner braking ring being fastened to the rotor body in an orientation substantially parallel with the disc portion and spaced from the inner disc surface;
an outer braking ring made of a second material, the outer braking ring being fastened to the rotor body in an orientation substantially parallel with the disc portion and spaced from the outer disc surface; and
a plurality of projections extending from at least one of the inner disc surface and the outer disc surface to support thereon the respective one of the inner braking ring and the outer braking ring, the plurality of projections being arranged in at least two radially-spaced circular rows about the disc portion, wherein the projections in any particular row are radially misaligned with the projections in any adjacent row.

24. The brake rotor of claim 23, wherein the rotor body is made of aluminum.

25. The brake rotor of claim 23, wherein the inner and outer braking rings are made of from a material selected from the group of steel, titanium, ceramic, or composite material.

26. The brake rotor of claim 23, wherein the inner and outer braking rings are connected to bosses defined by the rotor body adjacent the central hub portion, and wherein the inner and outer braking rings are connected to bosses defined by the rotor body at a location spaced from the central hub portion.

27. The brake rotor of claim 23, wherein the projections extend from both the inner disc surface and the outer disc surface to support the inner braking ring and the outer braking ring, respectively, a distance from the inner disc surface and the outer disc surface.

28. The brake rotor of claim 23, wherein at least one of the circular rows includes projections generally configured in elongated diamond-like shapes oriented along an axis extending radially outwardly from the central hub portion.

29. The brake rotor of claim 28, wherein adjacent diamond-shaped projections define cooling air passageways between a respective disc surface and braking ring.

30. The brake rotor of claim 28, wherein adjacent diamond-shaped projections are configured to accelerate a cooling airflow past a respective disc surface and braking ring.

31. A method of manufacturing a brake rotor, the method comprising:
forming a rotor body to have a hub portion and a disc portion extending from the hub portion, the disc portion having a first side and a second side;
configuring the first side of the disc portion with a plurality of support projections, configured to act like vanes;
the support projections on the first side of the disc portion partially forming a plurality of converging-diverging nozzles and partially defining cooling passageways through the brake rotor; and
fastening a braking ring to the first side of the disc portion of the rotor body such that the braking ring is supported by the support projections, the cooling passageways being defined by the disc portion of the rotor body, the support projections, and the braking ring.

32. A method as claimed in claim 31, further comprising configuring the second side of the disc portion with a plurality of support columellae; and
fastening a second braking ring to the second side of the disc portion of the rotor body such that the second braking ring is supported by the support columellae of the second side of the disc portion, a second plurality of cooling passageways being defined by the disc portion of the rotor body, the support columellae of the second side of the disc portion, and the second braking ring.

33. The method of claim 31, wherein forming the rotor body includes casting the rotor body from molten metal, and wherein the braking ring is stamped from sheet metal.

34. A brake rotor comprising:
a rotor body made of a first material, the rotor body including a central hub portion having a central axis and a disc portion extending from the central hub portion, the disc portion including a first surface and a second surface;
the first surface of the disc portion having a plurality of columellae arranged in concentric rings coaxial to the central axis;
the second surface of the disc portion having a plurality of columellae arranged in concentric rings coaxial to the central axis;
a first braking ring made of a second material, the first braking ring sized and shaped to be connected to the rotor body in an orientation substantially parallel with the disc portion, spaced from the first disc surface, and supported by the plurality of columellae of the first surface; and
a second braking ring made of a second material, the second braking ring sized and shaped to be connected to the rotor body in an orientation substantially parallel with the disc portion, spaced from the second disc surface, and supported by the plurality of columellae of the second surface.

35. The brake rotor of claim 34, wherein the first and second braking rings are fastened to the rotor body.

36. The brake rotor of claim 35, wherein the first and second braking rings are connected to bosses defined by the rotor body adjacent the central hub portion, and wherein the first and second braking rings are screwed or riveted to bosses defined by the rotor body at a location spaced from the central hub portion.

37. The brake rotor of claim 34, wherein, in at least one of the first and second surfaces of the disc portion, at least one of the concentric rings includes columellae generally configured in elongated diamond-like shapes oriented along an axis extending radially outwardly from the central axis.

38. The brake rotor of claim 37, wherein adjacent diamond-shaped columellae define cooling air passageways between a respective disc surface and braking ring.

39. The brake rotor of claim 37, wherein adjacent diamond-shaped columellae are configured to accelerate a cooling airflow past a respective disc surface and braking ring.

40. The brake rotor of claim 34, wherein each of the first and second braking rings have a plurality of apertures.

41. A brake rotor body comprising:
a hub portion having a central axis; and
a disc portion extending from the central hub portion, the disc portion including a first surface and a second surface;
the first surface of the disc portion having a first plurality of columellae arranged in a first ring coaxial to the central axis and a second plurality of columellae arranged in a second ring coaxial to the central axis;
the second surface of the disc portion having a first plurality of columellae arranged in first ring coaxial to the central axis and a second plurality of columellae arranged in a second ring coaxial to the central axis.

42. The brake rotor body of claim 41, wherein at least one of the first and second pluralities of columellae on the first and second surfaces are generally configured in elongated diamond-like shapes oriented along an axis extending radially outwardly from the central axis.

43. The brake rotor body of claim 41, wherein two adjacent collumellae in a particular ring at least partially form a converging-diverging nozzle to accelerate a cooling airflow past the columellae.

44. The brake rotor body of claim 41, wherein, in at least one of the first and second surfaces of the disc portion, the columellae of the first ring are misaligned with the columellae of the second ring.
